(19) United States
(12) Patent Application Publication
(10) Pub. No.: US 2012/0212932 A1
(43) Pub. Date: Aug. 23, 2012

(54) SPOTLIGHT

(76) Inventors: Vincent Guenebaut, Cork (IE); Thomas Hennessy, County Cork (IE); Mark Walshe, Cork (IE)

(21) Appl. No.: 13/389,670

(22) PCT Filed: Aug. 5, 2010
(86) PCT No.: PCT/IE2010/000045

§ 371 Date: May 3, 2012

(30) Foreign Application Priority Data
Aug. 13, 2009 (IE) 2009/0621

(51) Int. Cl. F21V 9/16; F21V 7/20

(52) U.S. Cl. 362/84; 362/218

(57) ABSTRACT

A spotlight comprises a base which is secured by nuts and washers to a support. There may be a single spotlight, or there may be a line of spotlights mounted on a support. Typical examples of use of the spotlight are illuminating displayed products such as jewellery, ceramics, clothes, or cosmetics. The locations may be retail stores, museums, or galleries for example. A main spotlight body is connected to the base by a joint having a bolt in a sleeve allowing rotation of about 180° around the bolt's axis. Further, the base can be secured to the support at any angular position about an axis through the base 2. Light emission is from an LED on a substrate, which is on an aluminium base, which has external threads engaging internal threads of a generally cylindrical casing. A focusing lens is mounted over the LED, and is retained in position by an inwardly-directed lip of the cylindrical casing.

### FIELD OF THE INVENTION

The invention relates to illumination of confined spaces where particularly good clarity is required, such as a jewellery display case in a retail store or museum.

### PRIOR ART DISCUSSION

Heretofore, an approach to such illumination has been to mount optical fibre assemblies in the case, and EP02654892 describes such an approach. However, this approach requires a considerable extent of bulky apparatus in the cabinet, including a light source housing, fibres running to the various illumination locations, and brackets to support the ends of the fibres and the lens units. Another problem is the limit on the extent of manipulation of fibres which is allowed: avoidance of sharp bends in order to avoid light beam attenuation. A further problem is that there is inefficient use of energy due to the extent of coupling required between the light source and the lens units.

Another approach is described in US2008/0007941. This involves use of fluorescent tube illuminators. However, these are bulky and have high energy consumption for the extent of illumination required.

The invention is directed towards providing an illuminator which is suited to applications such as jewellery case illumination, having the advantages of:

being compact, and/or

being robust, and/or

having a low energy consumption, and/or

having flexibility in terms of the direction of illumination, and/or

being simple to install and maintain.

### SUMMARY OF THE INVENTION

According to the invention, there is provided a spotlight comprising:

a base having a connector for connection to a support,

a main body connected to the base by a joint,

at least one LED in the main body, and

a lens over the LED.

In one embodiment, the main body has an outer casing which is removably connected to a base for the LED.

In one embodiment, the casing is of generally cylindrical configuration.

In one embodiment, the casing is threaded onto the base.

In one embodiment, the casing is configured to retain the lens.

In one embodiment, the casing has an inwardly-directed lip to retain the lens.

In one embodiment, the spotlight comprises an internal support of annular configuration supporting the lens. Preferably, the lens is partially housed within the lens support.

In one embodiment, the casing and the base are of a material having a high thermal conductivity and providing a heat conduction path from the LED to the environment via the substrate base and the casing. In one embodiment, the material is a metal such as aluminium

In one embodiment, the main body has a downwardly-depending leg for engagement with the joint. Preferably, said leg has a curved lower profile.

In a further embodiment, the joint comprises a bolt and a sleeve allowing rotation of the main body about the axis of the bolt.

In one embodiment, the connector allows rotation of the spotlight about an axis. In one embodiment, the casing retains a filter over the lens.

In another embodiment, there are a plurality of LEDs and at least two are of different colours. In one embodiment, there is at least one is white LED and at least one red LED. In one embodiment, the lens is configured for internal reflection to provide near light collimation. In one embodiment, the lens overlies and surrounds the LED.

In one embodiment, the LED is encapsulated. In one embodiment, the encapsulation incorporates phosphor.

In another aspect, the invention provides a spotlight assembly comprising an elongate support and a plurality of spotlights as defined above in any embodiment secured to the support.

In one embodiment, the support is channel-shaped and houses a drive circuit for the spotlight LEDs within a channel.

In one embodiment, the support comprises magnets for mounting on a metal surface.

### DETAILED DESCRIPTION OF THE INVENTION

### Brief Description of the Drawings

The invention will be more clearly understood from the following description of some embodiments thereof, given by way of example only with reference to the accompanying drawings in which:

FIG. 1 is a perspective view of a spotlight of the invention, and FIGS. 2 and 3 are elevational views;

FIGS. 4, 5, and 6 are views of the spotlight showing it at various orientations;

FIGS. 7 and 8 are cross-sectional diagrams through different vertical planes to illustrate construction of the spotlight in more detail, including how a power cable is trained to contact an LED substrate;

FIG. 9 is a cross-sectional diagram showing heat conduction paths in the spotlight; and

FIG. 10 is a cross-sectional view through a housing for a linear array of spotlights,

FIG. 11 is an elevational view of the array, and

FIG. 12 is a plan view; and

FIG. 13 is a perspective view from above of the array,

FIG. 14 is an end view, and

FIG. 15 is a rear view showing the interior of the housing.

### DESCRIPTION OF THE EMBODIMENTS

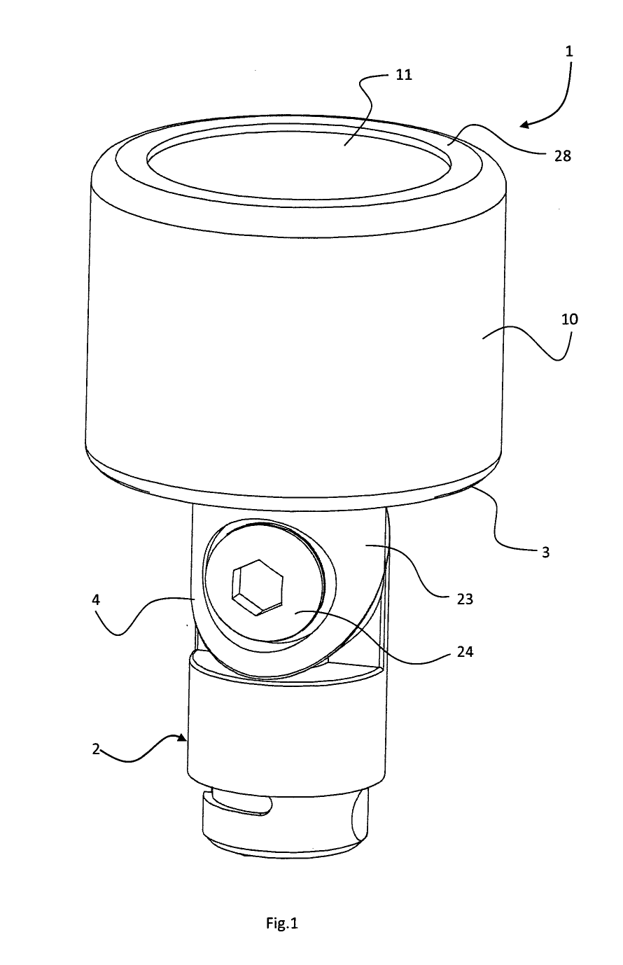

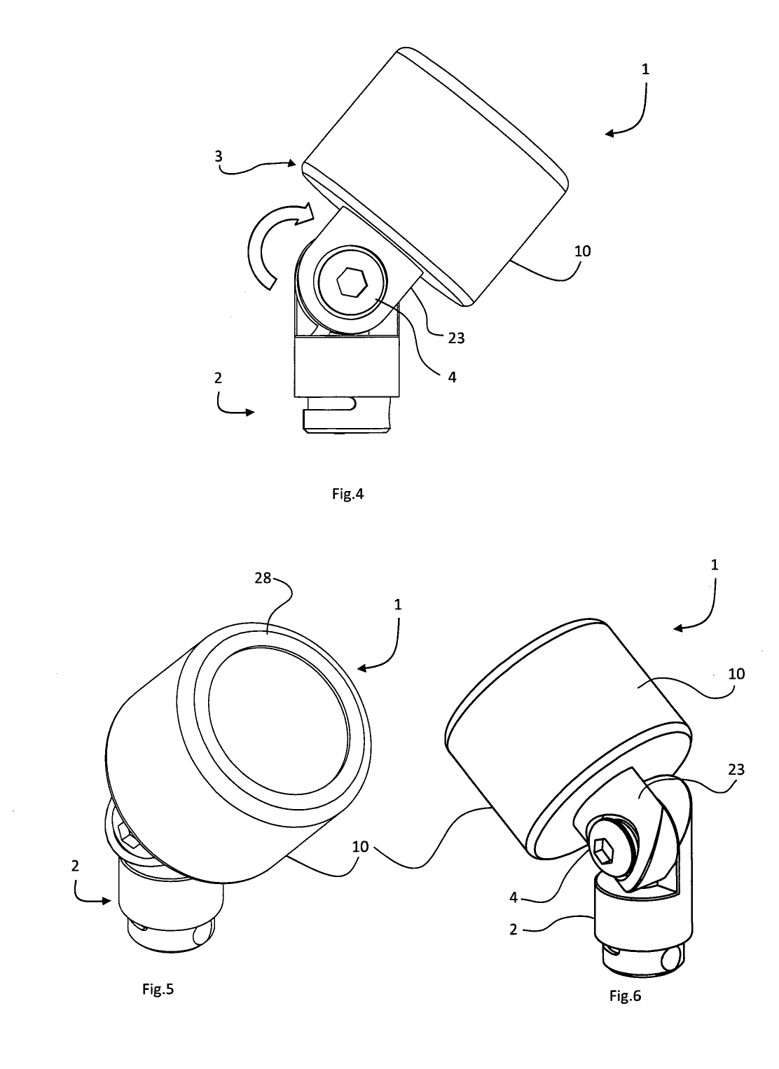

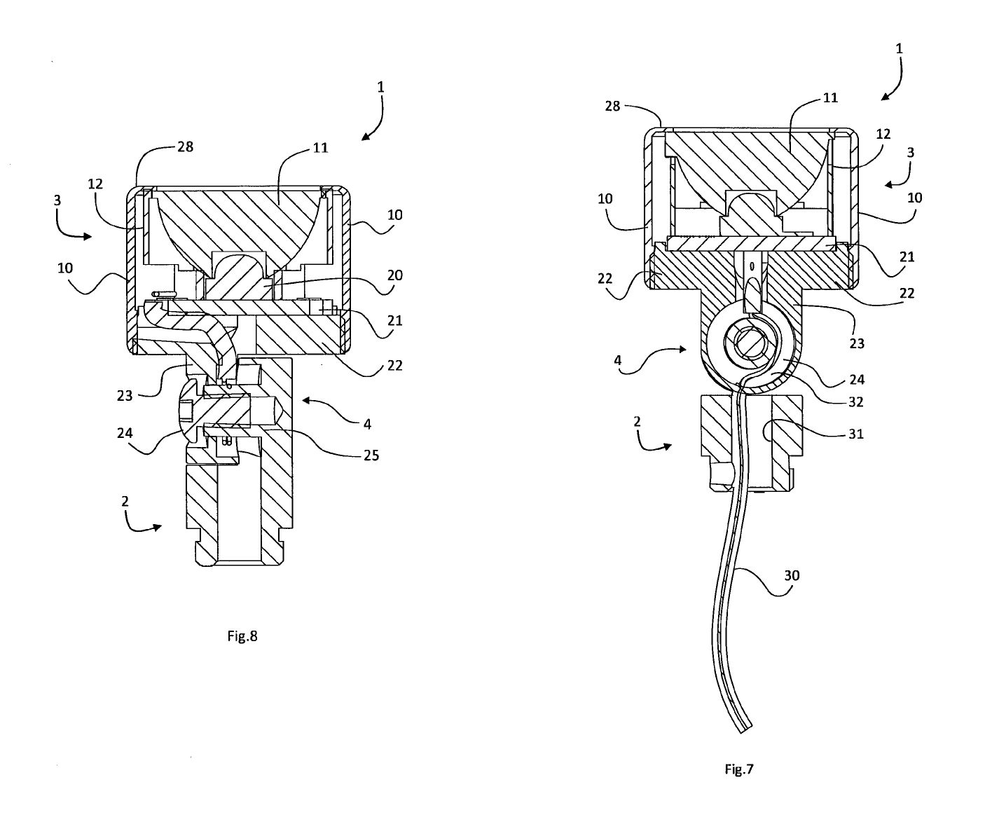

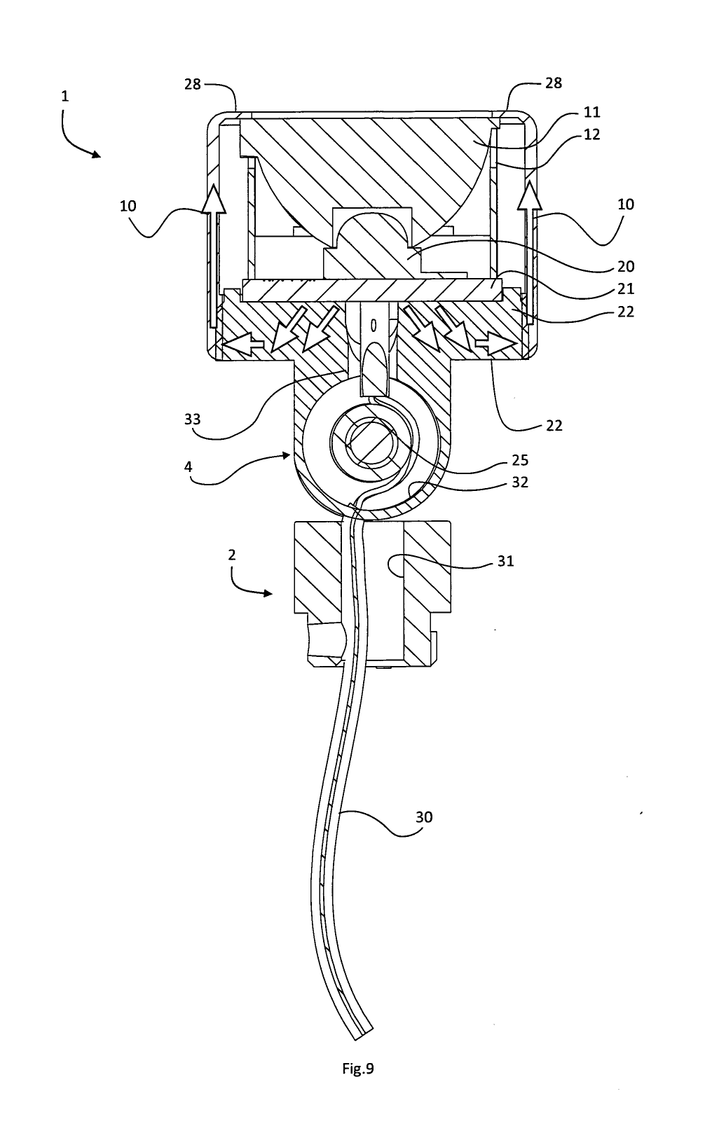

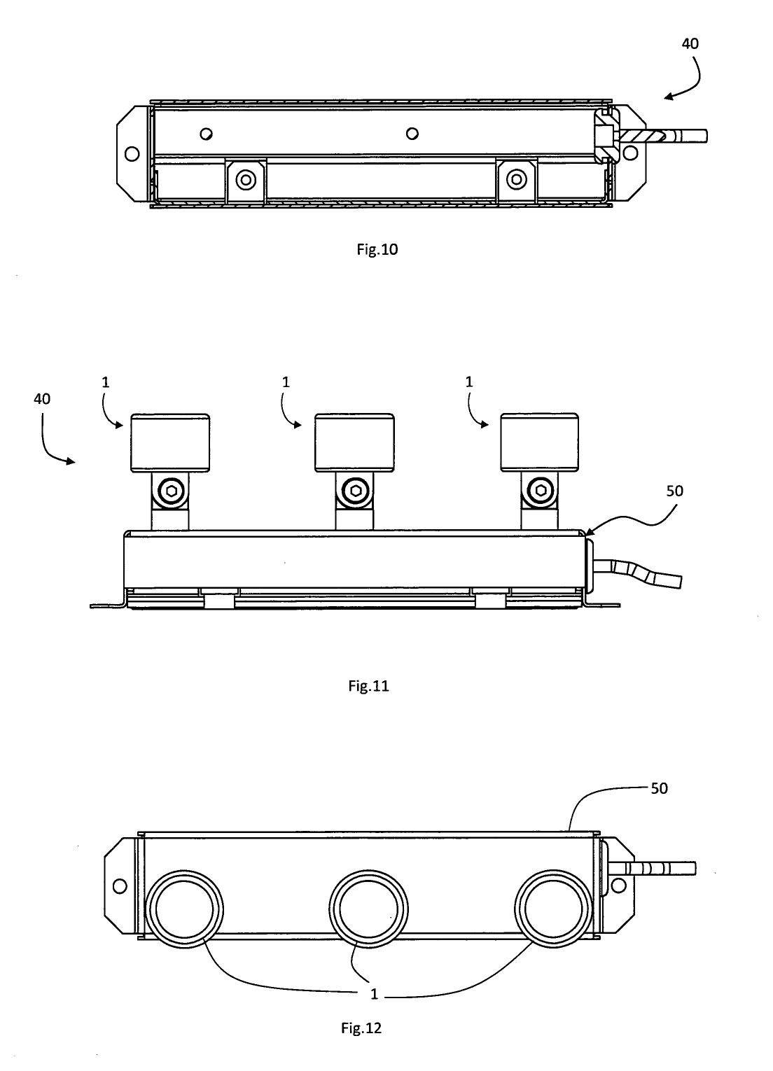

Referring to FIGS. 1 to 9 a spotlight 1 of the invention comprises a base 2 which is secured by nuts and washers to a support. There may be a single spotlight, or there may be line of spotlights mounted on a support (as shown in FIGS. 10 to 15). Typical examples of use of the spotlight are illuminating displayed products such as jewellery, ceramics, clothes, or cosmetics. The locations may be retail stores, museums, or galleries for example.

In this embodiment, the spotlight has an outer diameter of 25 mm, and is approximately 50 mm high.

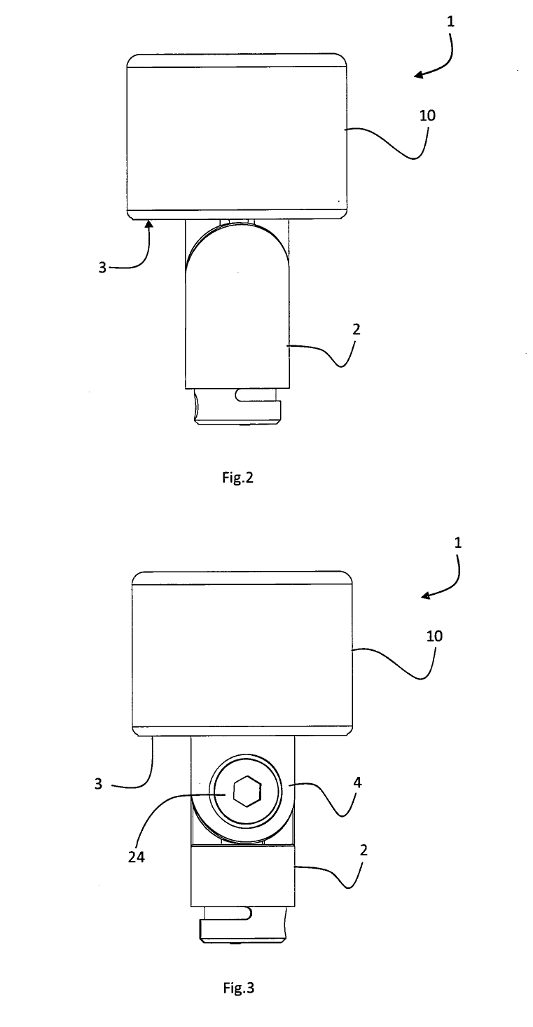

A main spotlight body 3 is connected to the base 2 by a joint 4 having a bolt 24 in a sleeve 25 allowing rotation of about 180° around the bolt's axis. Further, the base 2 can be secured to the support at any angular position about an axis (vertical as viewed in FIG. 1) through the base 2. Various angular positions about the bolt's axis are shown in FIGS. 4 to 6.

Light emission is from an LED 20 on a substrate 21. The substrate 21 is on an aluminium base 22, which has external threads engaging internal threads of a generally cylindrical casing 10. The base 22 also continues downwardly at a lower portion 23 to the joint 4.

A focusing lens 11 is mounted over the LED 20, and is retained in position by an inwardly-directed lip 28 of the cylindrical casing 10 and by an internal tubular lens support 12. The support 12 is of black plastics material. The lens 11 is configured for total internal reflection with near full collimation of light, and a full width half max (FWHM) angle of +/−12° . The LED 20 has a Colour Rending Index (CRI) of 94. It is an encapsulated LED, incorporating phosphor, which spreads the wavelength range to provide a yellow output. The spotlight may be provided with any of a number of different illumination characteristics due to its modular nature. For example there may be a choice of four different lighting angles by changing the lens (11): namely a 9.5° FWHM lens, a 15.4° FWHM lens, a 23.8° FWHM lens, and a 42.7° FWHM lens.

The casing 10 performs the varied functions of providing a housing for the main body of the spotlight, of retaining the lens 11 in position over the LED 20, and of allowing disassembly of the spotlight by simply being rotated about the base 22. Further, as shown by the arrows in FIG. 4 the base 22 provides a heat conduction path from the LED 20 through to the casing 10 for efficient heat dissipation and hence improved operation and longer life of the LED 20. There is also heat conduction downwardly into the base 2.

The LED 20 is powered by an electrical lead 30, which is trained via conduits 31, 32, and 33 in the spotlight base 2, the joint 4, and the substrate base 22 respectively. This arrangement allows the lead to be conveniently and without damage trained to the LED substrate 21 irrespective of the orientation. Provided there is play in the lead 30 then it can be pulled up and towards the LED substrate 21 as the body 3 is rotates about the joint 4 towards the horizontal position.

The mechanical arrangement of the casing 10 allows considerable versatility during manufacture and possibly also after installation if desired. For example, the casing 10 could retain a filter over the lens 11. The filter and the LED may be arranged to provide white light, either cool or warm. The emitted light can be set by a combination of multiple LEDs, for example white and red LEDs to provide a warmer colour temperature and high CRI (possibly close to 95).

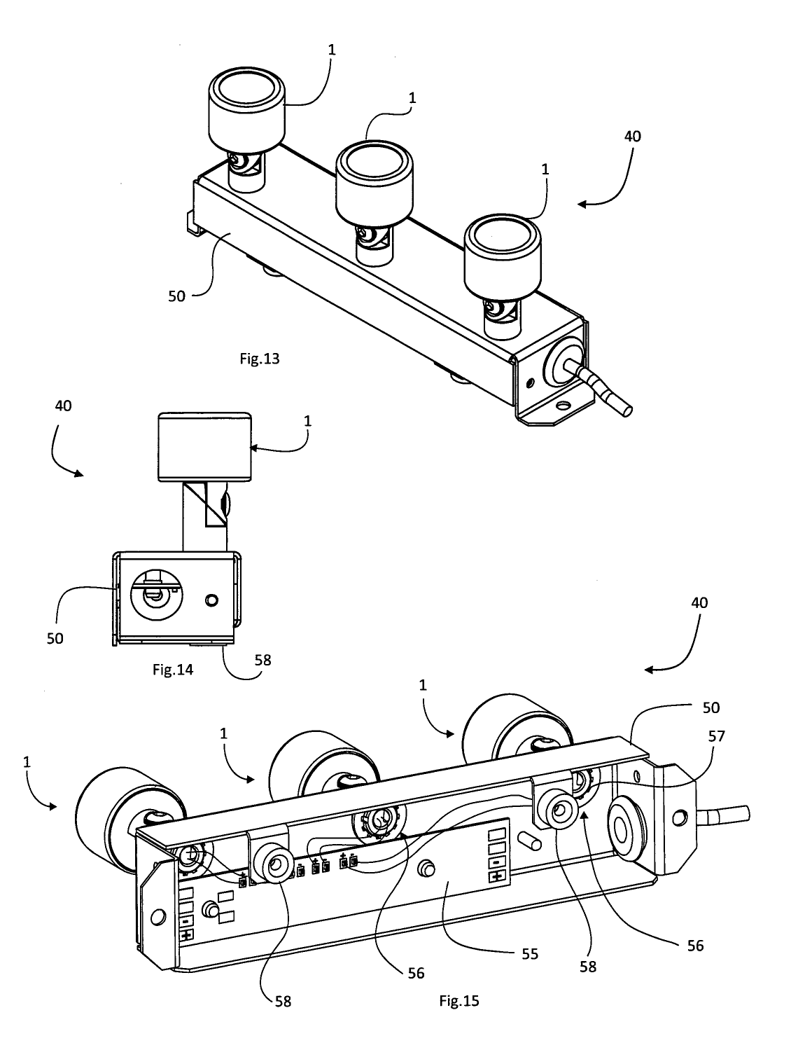

Referring to FIGS. 10 to 15 a number of the spotlights 1 may be mounted on an elongate support such as a channel 50 to provide a luminaire assembly 40. The spotlights 1 are mounted on an external surface of the channel 50, wiring and drive circuit boards being mounted inside the channel between the channel flanges, as best shown in FIG. 15. The channel 50 houses circuits 55 and fixtures 56 for securing the spotlights 1 to the channel 50. The fixtures 56 include a washer 57 configured with features to provide resistance to rotation of the base 2 with respect to the channel 50 and ensure that the spotlight 1 retains its position about this axis once moved (manually) to the desired position. The channel 50 also houses magnets 58 for easy installation onto a metal cabinet. The magnets 58 protrude just proud of the lower edges of the channel flanges, as best shown in FIG. 14. This illustrates versatility of the invention. It will be appreciated that the spotlight 1 is very simple, compact, and robust. It may be mounted individually in a display cabinet, and there could be several at different locations, power being provided by training the (thin) cable 30 in an unobtrusive manner to the spotlight. Where there is an array of spotlights, they can be turned as desired in a versatile manner to achieve several illumination directions. At installation, the installer may choose any desired configuration of lens and/or filter by simply un-screwing the casing 10 and inserting the desired lens and/or filter. The compact and simple physical configuration of the spotlight allows it to contribute to the aesthetics of the cabinet in which it is installed. It is anticipated that there would be excellent versatility due to the efficient conduction of heat away from the substrate 21 in several directions.

The invention is not limited to the embodiments described but may be varied in construction and detail.

1-24. (canceled)

25. A spotlight comprising:
a base having a connector for connection to a support,
a main body connected to the base by a joint,
at least one LED in the main body,
a lens over the LED,
wherein the main body has an outer casing which is removably connected to a base for the LED
wherein an LED power lead is trained via conduits in the spotlight base, the joint, and the main body base,
wherein the casing and the main body base are of a material having a high thermal conductivity and providing a heat conduction path from the LED to the environment via the main body base and the casing, and
wherein the main body has a downwardly-depending leg for engagement with the joint.

26. The spotlight as claimed in claim 25, wherein the casing is of generally cylindrical configuration, and is threaded onto the main body base.

27. The spotlight as claimed in claim 25, wherein the casing is configured to retain the lens, and wherein the casing has an inwardly-directed lip to retain the lens.

28. The spotlight as claimed in claim 25, wherein the spotlight comprises an internal support of annular configuration supporting the lens.

29. The spotlight as claimed in claim 25, wherein the spotlight comprises an internal support of annular configuration supporting the lens; and wherein the lens is partially housed within the lens support.

30. The spotlight as claimed in claim 25, wherein the material is a metal such as aluminium.

31. The spotlight as claimed in claim 25, wherein said downwardly-depending leg has a curved lower profile.

32. The spotlight as claimed in claim 25, wherein the joint comprises a bolt and a sleeve allowing rotation of the main body about the axis of the bolt.

33. The spotlight as claimed in claim 25, wherein the connector allows rotation of the spotlight about an axis.

34. The spotlight as claimed in claim 25, wherein the casing retains a filter over the lens.

35. The spotlight as claimed in claim 25, wherein there are a plurality of LEDs and at least two are of different colours.

36. The spotlight as claimed in claim 25, wherein the lens is configured for internal reflection to provide near light collimation, and wherein the lens overlies and surrounds the LED.

37. The spotlight as claimed in claim 25, wherein the LED is encapsulated, and wherein the encapsulation incorporates phosphor.

38. A spotlight assembly comprising an elongate support and a plurality of spotlights secured to the support, wherein each of said spotlights comprises:
a base having a connector for connection to a support,
a main body connected to the base by a joint,
at least one LED in the main body,
a lens over the LED,
wherein the main body has an outer casing which is removably connected to a base for the LED wherein an LED power lead is trained via conduits in the spotlight base, the joint, and the main body base,
wherein the casing and the main body base are of a material having a high thermal conductivity and providing a heat conduction path from the LED to the environment via the main body base and the casing, and
wherein the main body has a downwardly-depending leg for engagement with the joint.

39. The spotlight assembly as claimed in claim 38, wherein the support is channel-shaped and houses a drive circuit for the spotlight LEDs within a channel.

40. The spotlight assembly as claimed in claim 38, wherein the support comprises magnets for mounting on a metal surface.
